(19) United States
(12) Patent Application Publication
(10) Pub. No.: US 2024/0360855 A1
(43) Pub. Date: Oct. 31, 2024

(54) GLASS PRODUCT

(71) Applicant: CARLEX GLASS AMERICA, LLC, Nashville, TN (US)

(72) Inventors: Wladislaw Bronstein, Konz (DE); Philippe Dulski, Grevenmacher (LU); Olivier Farreyrol, Wasserbillig (LU); Markus Walter Pohlen, Mückeln (DE)

(73) Assignee: ACR II GLASS AMERICA INC., Nashville, TN (US)

(21) Appl. No.: 18/571,657

(22) PCT Filed: Jun. 16, 2022
(86) PCT No.: PCT/US2022/033832

§ 371 Date: Dec. 18, 2023

Related U.S. Application Data
(60) Provisional application No. 63/211,832, filed on Jun. 17, 2021.

(51) Int. Cl. F16B 5/00; B60J 1/02; B60J 10/70

(52) U.S. Cl. CPC F16B 5/0012; B60J 1/02; B60J 10/70

(57) ABSTRACT

A disclosed glass product comprises a first glass piece, a first encapsulation at an edge of the first glass piece, a first fastening at the first encapsulation, a second glass piece, a second encapsulation at an edge of the second glass piece, and a second fastening at the second encapsulation, wherein the first fastening and the second fastening are fastenable to each other to provide a large glazing.

### CROSS REFERENCE TO RELATED APPLICATIONS

This application is a national phase entry of PCT/US2022/033832 filed Jun. 16, 2022, which claims priority to U.S. Provisional Application No. 63/211,832, filed on Jun. 17, 2021, entitled “GLASS PRODUCT,” the entire contents of which are incorporated by reference herein in their entirety.

### TECHNICAL FIELD

The present disclosure is generally related to a glass product having multiple glass pieces connected by fastenings.

### BACKGROUND

Large glazings may be used in automobiles. For example, a large windshield may be provided that extends above the driver to include part of a sunroof area. Such large constructions may be difficult to produce and bend. There is a need for alternative products which may provide a desired glass appearance for automobiles.

### SUMMARY OF THE DISCLOSURE

To utilize large glazings for automobiles or other products, products as disclosed herein may be provided. Particularly, a glass product according to this disclosure may comprise a first glass piece, a first encapsulation at an edge of the first glass piece, a first fastening at the first encapsulation, a second glass piece, a second encapsulation at an edge of the second glass piece, and a second fastening at the second encapsulation wherein the first and second fastenings are connectable to each other.

As disclosed herein, the first glass piece may include multiple first fastenings, and the second glass piece may include multiple second fastenings. The glass product may include the first and second fastenings fastened together at multiple points along the edges of the first and second pieces. The glass product disclosed herein may further comprise a fastener or fasteners for facilitating connection between first and second fastenings. Such a fastener or fasteners may be made of a material different from that of the first and second fastenings. The glass product may include a bridge piece for connecting the first glass piece and the second glass piece. In some embodiments, the fasteners may be male threaded and the fastenings may be female threaded.

The first and second fastenings may fit together to accept a fastener. The fastenings may be formed of a material different from the encapsulations and may be formed of a metal. In some further embodiments, an adhesive may be used in combination with the fastener.

The first and second fastenings may fasten together without additional pieces. In some embodiments, the first and second fastenings may fasten to each other with use of adhesive. Alternatively, the first and second fastenings may be mechanically fastened. A functional element may be encapsulated at the edge of the first glass piece or the edge of the second glass piece. In some embodiments, the first glass piece may be a windshield whereas the second glass piece may be a sunroof. A sealant may further be provided where the first encapsulation meets the second encapsulation.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a plan view of a glass product having first and second glass pieces with fasteners, according to an embodiment of the present disclosure, prior to connection;

FIG. 2 illustrates a cross section of the glass product shown in FIG. 1, after connection;

FIG. 3 illustrates a cross section of another glass product having first and second glass pieces with fasteners prior to connection, according to another embodiment of the present disclosure;

FIG. 4 illustrates a cross section of the glass product shown in FIG. 3, after connection; and

FIG. 5 illustrates a cross section of yet another glass product having first and second glass pieces with fasteners and adhesive prior to connection, according to yet another embodiment of the present disclosure.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below.

A multi-part glazing may be used to provide a large glazing which may otherwise be difficult to produce due to size and curvature of such a part. Such a glass product may include at least two glass pieces to form a glazing structure having a shape which may be difficult with conventional glass bending methods. Such difficulties may include creating a suitable construction for head-up display systems or for cameras and other sensors which may be positioned at the glass structure. The glass product may include a first glass piece which forms a major portion of the glass product. At least one additional glass piece may be formed along the first glass piece. In some embodiments, the first glass piece may be a windshield, a sunroof, or a back window. For example, a glass product may include a windshield as a first glass piece and a sunroof as a second glass piece. A glass piece in some glass products may include a portion for head-up display or for a camera or other sensor. In some embodiments, a sunroof portion may extend over part of a vehicle roof when installed. The vehicle may further include an additional sunroof glazing.

Particularly, the first and second glass pieces may each be encapsulated with fastening means. The encapsulation may include typical encapsulation materials which may include resin materials. The fastenings within the encapsulations may be fastened together to provide the glass product having first and second glass pieces. The fastenings provided in each of the glass pieces may complement each other such that they can be fastened together. The fastenings may be provided on edges of the first and second glass pieces facing each other. The fastenings may extend along the entire edge of the first glass piece and the edge of the second glass piece, part of the edges, or may be positioned in multiple places along the edges. The fastenings may be any suitable material, such as a metal, which may include steel. The fastenings may be partially positioned within an encapsulation material along an edge of the first glass piece and along an edge of the second glass piece. The portion of the fastenings that are not encapsulated may be suited for fastening to each other. The fastening may include, for example, a mechanical attachment. The fastenings may fasten to each other by any suitable means, such as by attachment of a bolt or a pin.

Encapsulation material, which may include a resin material, may be applied to the first and second glass pieces. The encapsulation material may be applied by encapsulation methods known in the art and may surround part of the fastenings. Each glass piece may be fully surrounded by the encapsulation material along the glass piece edges. The encapsulation material may include a polymer material, including a polyurethane, or other suitable binding material. Particularly, encapsulation material may be thermosetting or a thermoplastic resin, and may be, e.g., epoxy resin, phenolic resin, polyimide, polyurethane, PVC (polyvinyl chloride), ABS (acrylonitrile butadiene styrene) resin, polycarbonate, acrylic resin, polyamide, POM (polyacetal) resin, PET (polyethylene terephthalate), PBT (polybutyleneterephthalate) resin, etc., or a combination of those resins, fiber reinforced resin materials, elastomers, etc.

The encapsulation material may be colored or not colored. Where the encapsulation material is colored, the glass pieces may be printed with a matching color, such that the meeting point between the glass pieces may be less apparent. Particularly, an encapsulation material may be black. Encapsulation may include placing the glass pieces and fastenings in a mold and filling a space around the glass pieces with an encapsulation material. The glass pieces may be encapsulated separately. In some embodiments, the encapsulation material may provide an additional function, such as a rain guide. Further, the encapsulation material may interact with accessories or functional elements located behind the encapsulation material, in the glass product or where the glass product is installed.

The encapsulation material may further house a functional element. For example, a lighting structure may be incorporated into the material to provide an ambient or reading light source. A sensor or camera may also be provided as a functional element attached within the encapsulation material. The functional element in the encapsulation material may include a device or an attachment for a device. For example, an attachment for a mirror may be held within the encapsulation material. The functional element may be encapsulated at the edge of either the first glass piece or the second glass piece.

The glass pieces used in such a glass product may include laminated or single glass sheets. A glass pieces within a glass product as disclosed herein may have the same or different glass constructions. The glass pieces may, for example, have the same or different, material compositions, light transparency, and stacks of materials, including number and thickness of glass sheets, coatings, and interlayers. The glass pieces may be bent to a desired shape. A conventional laminated glazing may include a first glass sheet, an interlayer, and a second glass sheet laminated together. The glass sheets may be bent to a desired shape prior to lamination with an interlayer therebetween. Preferably, the glass sheets may be a soda-lime silica glass. Glass bending may preferably occur by heat treatment from 550° C. to 700° C., more preferably from 580° C. to 660° C. The interlayer may include an adhesive polymer sheet, which may include polyvinyl butyral (PVB) or ethylene vinyl acetate (EVA). An interlayer may include an ionomer sheet in some glazings. An inner glass sheet of the glazing faces a vehicle interior when installed, and an outer glass sheet faces a vehicle exterior when installed.

In some embodiments the first glass piece may be coated or include a functional film laminated therein. The additional glass pieces may include the same or different coatings or functional films as the first glass piece in some embodiments; however, further embodiments may include additional glass pieces without coatings or functional films.

The glass products disclosed herein may be provided as a single unit, such that the glass product having multiple glass pieces may be installed as a single piece. The glass pieces which fasten together may be provided separately instead such that they may be fastened together after shipping. The structure described herein may allow for individual replacement of the glass pieces later where one but not all glass pieces needs to be replaced.

FIG. 1 shows a glass product 10 prior to coupling of a first glass piece 12 and a second glass piece 14. In some embodiments, the first glass piece 12 may be used as a windshield for an automobile and the second glass piece 14 may be used as a sunroof for the automobile. The first glass piece 12 may have an edge covered with an encapsulation 16, and the second glass piece 14 may have an edge covered with an encapsulation 18. The encapsulations 16, 18 may include nuts 20, 22 as the first and second fastenings. The nuts 20, 22 may be oriented to provide suitable fastening of the glass pieces 12, 14. In some embodiments, the nuts 20, 22 may be aligned in a line.

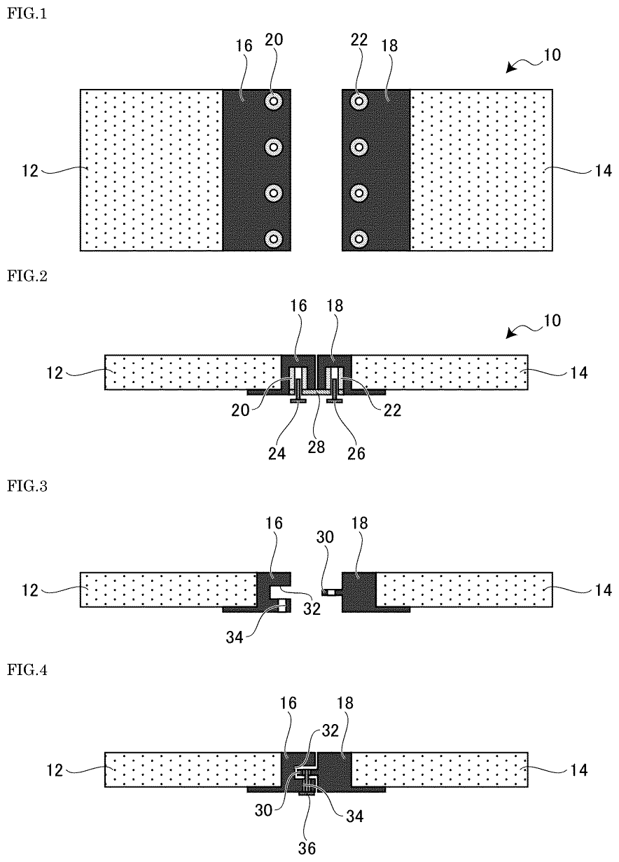

In some embodiments, as shown in FIG. 2, an additional bridge piece 28 may be used to connect the first and second glass pieces 12, 14. The fastenings 20, 22 for receiving a fastener 24, 26, which may include a bolt or pin, for example, may be held to the glass pieces 12, 14 within the encapsulation material. The fasteners 24, 26 may be fitted within the fastenings 20, 22 through a bridge piece 28, as shown in FIG. 2 and as described below, to attach the first and second glass pieces 12, 14 together. The first and second fasteners may be male threaded or bolts 24, 26 and the first and second fastenings may be female threaded, or the nuts 20, 22.

FIG. 2 shows the glass product 10 after coupling. The first encapsulation 16 on the edge of the first glass piece 12 comes to contact with the second encapsulation 18 on the edge of the second glass piece 14 via the bridge piece 28. A bridge piece 28 may be provided to fasten the first and second glass pieces 12, 14. The bridge piece 28 may be formed of a metal or plastic strip. The bridge piece 28 may have holes located corresponding to the positions of the nuts 20, 22 formed in the encapsulations 16, 18. When the first glass piece 12 and the second glass piece 14 are set to an assembly position, the positions of each hole in the bridge piece 28 may match the position of a respective nut 20, 22 formed in the encapsulations 16, 18. After the first glass piece 12 and the second glass piece 14 are set to the assembling position, bolts 24, 26 as the first and second fasteners may be inserted into the holes of the bridge piece 28 and the nuts 20, 22 to fasten the bridge piece 28 to the encapsulations 16, 18.

The glass product 10 may further include sealant where the first encapsulation 16 and the second encapsulation 18 meet. The sealant may be applied after the first glass piece 12 and the second glass piece 14 are connected to provide protection to the connection and prevent water or other material from entering a vehicle when the glass product 10 is installed. The sealant may be formed with any suitable sealant material for filling spaces between the first encapsulation 16 and the second encapsulation 18, including adhesives, such as polyurethane.

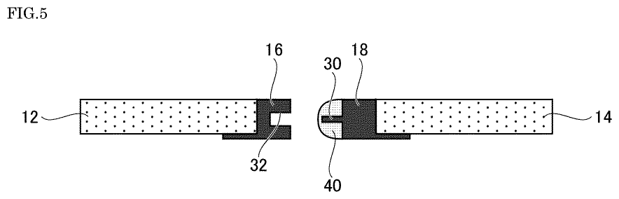

FIG. 3 shows another fastening structure which may be positioned within an encapsulation material. As shown, the fastenings 30, 32 may fit together to accept a fastener 36 for attaching the glass pieces 12, 14 together. In some embodiments, fastenings for accepting a fastener may be formed from a material different than the encapsulation material, such as a metal. FIG. 3 and FIG. 4 show another glass product according to an embodiment of this disclosure. FIG. 3 illustrates a state prior to coupling of the first and second glass pieces 12, 14. FIG. 4 illustrates a state after the coupling of the first and second glass pieces 12, 14. As shown in FIG. 3, the first glass piece 12 may have an encapsulation 16 having a groove 32 that can be fitted to projections 30 formed on the edge of the encapsulation 18. The groove 32 may serve as a first fastening, while the projection 30 may serve as a second fastening for this coupling. The projection 30 may have a flat plate like shape and a hole or holes corresponding to a hole or holes 34 formed through the encapsulations 16 to the groove 32. The shape of the projection 30 may fit into the groove 32. The projection 30 may be formed of the same material as encapsulation 18 or of a material different from the encapsulations 18. When the coupling is made with a pin 36, the pin 36 may be inserted into the hole 34 as well as the hole formed in the projection 30. The pin 36 may serve as a fastener to prevent the second glass piece 14 from disengaging from the first glass piece 12. The glass product may further include a sealant applied where the first encapsulation 16 meets the second encapsulation.

In some embodiments, the fastenings may include an adhesive, such as a polyurethane based adhesive. FIG. 5 illustrates an example embodiment where the fastenings 30, 32 are formed such that they may fit together with an adhesive 40. The adhesive 40 may include polyurethane resin. In some embodiments, the fastenings 30, 32 may be formed of the encapsulation material. The fastenings 30, 32 may connect at one area of fastening or at multiple fastening points. The adhesive 40 may act as a sealant between the fastenings 30, 32.

In FIG. 5, an adhesive 40 may be provided around the projection 30 as well as the groove 32. After coupling of the first glass piece 12 and the second glass piece 14, the adhesive 40 works to provide secure coupling between the glass piece 12 and the second glass piece 14. In FIG. 5, the groove 32 serves as a first fastening, while the projection 30 serves as a second fastening for this coupling.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glass product, comprising:
a first glass piece;
a first encapsulation at an edge of the first glass piece;
a first fastening at the first encapsulation;
a second glass piece;
a second encapsulation at an edge of the second glass piece; and
a second fastening at the second encapsulation,
wherein the first fastening and the second fastening are fastenable to each other.

2. The glass product according to claim 1, wherein the first glass piece includes multiple first fastenings, and the second glass piece includes multiple second fastenings.

3. The glass product according to claim 2, wherein the first and second fastenings fasten together at multiple points along the edges of the first and second glass pieces.

4. The glass product according to any one of claims 1 to 3, further comprising:
a first fastener to be received by the first fastening;
a second fastener to be received by the second fastening; and
a bridge piece which is fastened to the first encapsulation by the first fastener and the first fastening and fastened to the second encapsulation by the second fastener and the second fastening.

5. The glass product according to claim 4, wherein the first and second fasteners are male threaded and the first and second fastenings are female threaded.

6. The glass product according to any one of claims 1 to 3, further comprising a fastener for attaching the first and the second glass pieces,
wherein the first and second fastenings fit together to accept the fastener.

7. The glass product according to claim 6, wherein the first and second fastenings are formed of a material different from that of the first and second encapsulation.

8. The glass product according to claim 7, wherein the first and second fastenings are formed of a metal.

9. The glass product according to any one of claims 6 to 8, wherein the first and second fastenings fasten to each other with the fastener and an adhesive.

10. The glass product according to any one of claims 1 to 3, wherein the first and second fastenings fasten together without additional pieces.

11. The glass product according to claim 10, wherein the first and second fastenings fasten to each other with adhesive.

12. The glass product according to any one of claims 1 to 11, wherein the first glass piece is a windshield and the second glass piece is a sunroof.

13. The glass product according to any one of claims 1 to 12, wherein the first and second fastenings are mechanically fastened.

14. The glass product according to any one of claims 1 to 13, further comprising a functional element encapsulated at the edge of the first glass piece or the edge of the second glass piece.

15. The glass product according to any one of claims 1 to 14, further including a sealant where the first encapsulation meets the second encapsulation.
